(19) United States
(12) Patent Application Publication
(10) Pub. No.: US 2005/0027616 A1
(43) Pub. Date: Feb. 3, 2005

(54) On-line distribution of per-use media with flexible purchase options

(76) Inventors: Clyde T. Jones, Oakland, CA (US); Kevin R. Hsieh, San Francisco, CA (US); Tuyen N. Vo, Oakland, CA (US)

Correspondence Address: Dergosits & Noah LLP, Suite 1450, Four Embarcadero Center, San Francisco, CA, 94111, US

(21) Appl. No.: 10/902,926

(22) Filed: Jul. 30, 2004

Related U.S. Application Data
(60) Provisional application No. 60/491,948, filed on Aug. 1, 2003.

(51) Int. Cl. G06F 17/60

(52) U.S. Cl. 705/26

(57) ABSTRACT

A system for the on-line distribution and sales of electronic content over a distributed client-server network is described. A server computer maintains a database and processing engine that stores and processes data pertaining to a selection of digital content product, such as music CDs, movie DVDs, video games, computer software, and the like. A user registers for a membership on the vendor web site. Users may select from a wide range of products available through the vendor or other vendors associated with the web site. The user can search for auctions for individual titles or products. When the user wins an auction, the vendor sends the product for use during a trial period. The auction price sets the trial price for the product. Upon expiration of the trial period, the user can return the product to the vendor, or keep it and pay a price based on the trial price. The ultimate sales price is determined through a fixed price model that takes into account various factors such as trial price, wholesale price, msrp, stock levels, popularity, and so on. The trial price can be determined through the auction, or through a fixed-price model. The trial price can be wholly or partially deducted from the final sales price.

### FIELD OF THE INVENTION

The present invention relates generally to computer network and electronic commerce systems, and more specifically to a system and method for distributing electronic content over distributed client-server networks.

### BACKGROUND OF THE INVENTION

The advent of the Internet and web-based electronic commerce (“e-commerce”) systems has facilitated the sales and distribution of products and services from vendors to customers. With the increasing digitization of traditional analog-based entertainment media and content, downloading of programs and products directly to user home computers is becoming a popular method of product distribution. Music, movies, television shows, video games, on-line books, and many other electronic content products are increasingly being made available in high quality digital media, such as compact disks (CD's) and Digital Versatile Disks (DVD's), as well as compressed digital file formats, such as MP3. Despite technological advances in network systems to support the creation, distribution, and playback of such digital products, the business models governing the sales and payment of these products is still rooted in traditional buyer-seller transactional methods. Retail outlets, such as record stores, video rental stores, and video game stores remain popular sources of buying or renting entertainment products.

On-line services have been developed to move buyers from the traditional store-front environment to the e-commerce model in which a web-based interface is typically used by a buyer to access and select products offered by a vendor who then ships or mails the product to the buyer. Such present services, however, often impose cumbersome transaction processes to overcome the security, fraud, and other problems associated with remote transactions that do not require person-to-person interaction. For example, on-line vendors may require users to set up accounts or subscriptions with the vendor. This imposes greater costs and commitment on the part of the buyer, and may limit buyer choice and convenience. Present on-line methods also typically rely on outright sales of a product and do not facilitate the rental, leasing, trial, or short-term use of a product, since control or accountability of use over a product is difficult to manage in an on-line setting.

What is needed, therefore, is an e-commerce system that facilitates a per-use purchase or rental service for the distribution of electronic content over a computer network.

What is further needed is an on-line sales and rental system that allows users to choose from a wide variety of product, and that allows users to choose flexible pricing and usage terms.

### SUMMARY OF THE PRESENT INVENTION

A system for the on-line distribution and sales of electronic content over a distributed client-server network is described. A server computer maintains a database and processing engine that stores and processes data pertaining to a selection of digital content product, such as music CDs, movie DVDs, video games, computer software, and the like. These products are generally available for purchase at a price set by an auction process or through pre-defined or market set prices. A user registers for a membership on the vendor web site. Users may select from a wide range of products available through the vendor or other vendors associated with the web site. The user can search for auctions for individual titles or products and bid on a product through an available auction. When the user wins an auction, the vendor sends the product to the user for use during a trial period. The auction price sets the trial price for the product. Upon expiration of the trial period, the user can return the product to the vendor, or keep it and pay a price based on the trial price. The ultimate sales price is determined through a fixed price model that takes into account various factors such as trial price, wholesale price, MSRP, stock levels, popularity, and so on. The trial price can be determined through the auction, or through a fixed-price model. The trial price can be wholly or partially deducted from the final sales price.

Other features and advantages of the present invention will be apparent from the accompanying drawings and from detailed description that follows.

### BRIEF DESCRIPTION OF THE DRAWINGS

The present invention is illustrated by way of example and not limitation in the figures of the accompanying drawings, in which like references indicate similar elements, and in which:

FIG. 1 illustrates a computer network that includes client computers coupled to a server computer, and that is used to implement embodiments of the present invention;

FIG. 2 is a block diagram of an exemplary computer that can be used to implement embodiments of the present invention;

FIG. 3 is a flowchart illustrating the steps of an on-line product distribution and sales method, according to one embodiment of the present invention; and

FIG. 4 is a flowchart illustrating the steps of a shipping process for the on-line distribution and sales method, according to one embodiment of the present invention.

### DESCRIPTION OF THE PREFERRED EMBODIMENTS

An on-line product sales and distribution system is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Hardware Overview

Aspects of the present invention may be implemented on one or more computers executing software instructions. According to one embodiment of the present invention, server and client computer systems transmit and receive data over a computer network, standard telephone line, wireless network, or similar network infrastructure. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers.

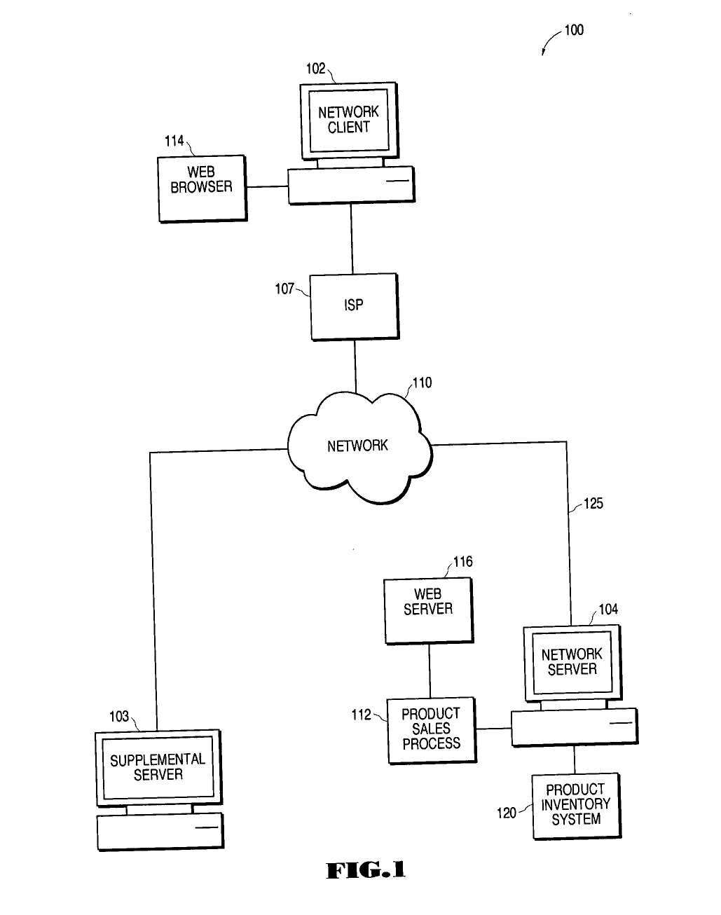

FIG. 1 illustrates a computer network system 100 that implements one or more embodiments of the present invention. In system 100, a network server computer 104 is coupled, directly or indirectly, over line 125 to one or more network client computers 102 through a network 1 10. The network interface between server computer 104 and client computer 102 may also include one or more routers (not shown) that serve to buffer and route the data transmitted between the server and client computers over line. Network 110 may be the Internet, a Wide Area Network (WAN), a Local Area Network (LAN), wireless network (e.g., 802.11) or any combination thereof.

In one embodiment of the present invention, the server computer 104 is a World-Wide Web (WWW) server that stores data in the form of ‘web pages’ and transmits these pages as Hypertext Markup Language (HTML) files over the Internet network 110 to the client computer 102. For this embodiment, the client computer 102 typically runs a “web browser” program 114 to access the web pages served by process 116 in server computer 104.

In one embodiment of the present invention, server 104 in network system 100 is a server that executes a product sales process 112. This process allows a user on client computer 102 to access a selection of products available from the server computer and enter into a sales or rental transaction with the vendor operating the server computer. Also executed by the server computer is a product inventory system 120. This is typically implemented as a database type of program for storing and managing the inventory of products available through the sales process 112. The product sales process 112 and/or product inventory system 120 may represent one or more executable program modules that are stored within network server 104 and executed locally within the server. Alternatively, however, they may be stored on a remote storage or processing device coupled to server 104 or network 110 and accessed by server 104 to be locally executed. In a further alternative embodiment of the present invention, the programs 112 and 120 may be implemented in a plurality of different program modules, each of which may be executed by two or more distributed server computers coupled to each other, or to network 110 separately.

Storage of the actual product to be sold and delivered to the customer may be controlled by the vendor through server computer 104 or an off-site facility, such as that maintained by a supplemental server 103. The supplemental server may serve as a content provider that downloads content on demand to the client 102, or it may be a warehouse computer that is used to ship actual product to the customer.

In one embodiment of the present invention, wherein network 110 is the Internet, network server 104 and content provider 103 execute a web server process 116 to provide HTML documents to client computers coupled to network 110. To access the HTML files provided by server 104, client computer 102 runs a web client process 114 (typically a web browser, such as Netscape Navigator™ or Microsoft Explorer™) that accesses and provides links to web pages available on server 104 and other Internet server sites. It should be noted that a network system 100 that implements embodiments of the present invention may include a larger number of interconnected client and server computers than shown in FIG. 1. For this embodiment, the client computer 102 may access the Internet network 110 through an Internet Service Provider (ISP) 107.

As can be appreciated by those of ordinary skill in the art, the representative networked computers of FIG. 1, such as network server computer 104 can be implemented as any standard computer that includes a CPU coupled through a bus to various other devices. These devices could include random access memory (RAM), a read only memory (ROM), and mass storage devices (e.g., a magnetic disk, optical compact disk, or tape drive for storing data and instructions). The computer also typically includes input/output devices, such as, a display device, keyboard, and network interface device, along with other similar devices or interfaces. Any of the computers in FIG. 1 could be implemented in the form of personal computers, laptop computers, mainframe computers, or other type of workstation computers.

For example, the content provider supplemental server 103 may be a computer that is maintained by an intermediate third party, such as a product manufacturer to provide content data or product to either the network client 102 or the network server 104 in relation to a product order that is process by server 104 computer. Likewise, client computer 102 maybe a game console, playback device, personal computer, personal digital assistant, cellular phone, or similar type of networkable computing device that is able to process content data transmitted by the server computers 103 or 104.

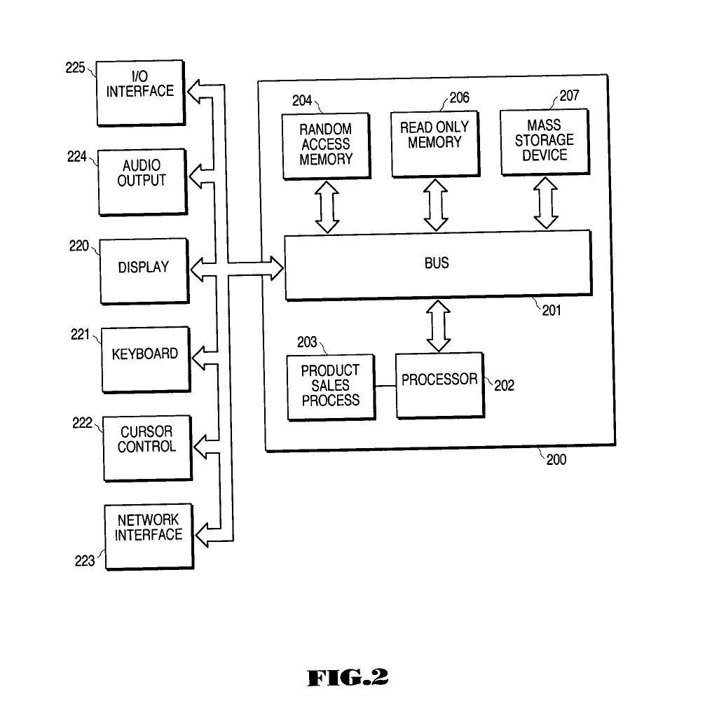

FIG. 2 is a block diagram of a representative networked computer, such as network server computer 104 or client 102 illustrated in FIG. 1. The computer system 200 includes a processor 202 coupled through a bus 201 to a random access memory (RAM) 204, a read only memory (ROM) 206, and a mass storage device 207. Mass storage device 207 could be a magnetic disk, optical compact disk, or tape drive for storing data and instructions. A display device 220 for providing visual output is also coupled to processor 202 through bus 201. Keyboard 221 and cursor control unit 222 are coupled to bus 201 for communicating user commands to processor 202.

Also coupled to processor 202 through bus 201 are additional ports, such as audio output port 224, an input/output (I/O) interface 225, and a network interface device 223. Network interface device 223 provides a physical and logical connection between computer system 200 and a network. It is used by various communication applications running on computer 200 for communicating over the network medium, and may represent devices such as an Ethernet card, ISDN card, modem, or similar devices. It should be noted that the architecture of FIG. 2 is provided primarily for purposes of illustration, and that a server or client computer used in conjunction with the present invention is not limited to the specific architecture shown.

In one embodiment of the present invention, processor 202 within computer system 200 executes one or more software routines that comprise a product sales and distribution program 203 that is implemented by a server computer, such as server 104 in FIG. 1.

For the embodiment in which network 110 is the Internet, communication between the client 102 and server 104 computers is typically implemented through the World Wide Web. In this case, the web server process 116 provides a graphical user interface screen for a web browser program 114 executed on client computer 102. Data content provided by the web server typically comprise web pages in the form of HTML, XML (Extensible Markup Language), or similarly coded, documents over network 110.

Product/Content Distribution

In one embodiment of the present invention, the products sales process 112 comprises program modules that allow customers to rent, buy or try out various different digital media that are available from different manufacturers and vendors, and in various different formats. Such products can include music CDs, video games, DVDs, software programs, electronic books, movies, streaming data, or any similar content that is available in a digital format that is transmittable over network 110. The business model for distributing such content is based on either subscription style services, or per-rental/per-use offers. Such a model can be used to span across a wide range of media and rental related items. In addition to electronic-based media, embodiments of the present invention can also be used to distribute traditional product media, such as computer disks, videocassettes, CDs, DVDs, paper books, magazines, articles, and so on.

The vendor or operator of server 104 maintains a business that manages the product inventory through system 120. A customer registers for a free, or fee-based membership on the web site and is then allowed to use the system. Products are either available for rent or purchase or trial use. Such products are listed on the web site. Also maintained or linked to the process 112 are a list of auctions that are run for at least a subset of products available through the system. Customers can search for auctions for individual titles/products. Each title/product may have multiple copies up for auction. When a customer wins an auction, they receive the item they won for a trial period to see if they like it. If they do not like it, the customer can send it back before the trial period expires. The trial period represents a finite period of time during which the customer can evaluate the product without incurring a cost for using the product. Once the trial period is over, cost for use of the product starts to accrue. If the customer opts to keep the item, it will be made available for a price that may be based on the membership status of the customer. The price may also include other components such as promotional discounts, alternative compensation, and other similar factors. Although membership in the program may be free or at a minimal cost, status as a member in the system may allow a customer to pay costs at a reduced or preferred rate. Typically membership is required to identify a customer within the system, and allow convenient access and processing of frequent users of the system. Membership also provides a means for allowing the system administrator to validate customers and maintain a list of valid users versus users who may be fraudulent. A fee-based membership may be established if the system administrator provides certain value-added services such as game/movie/program reviews, recommendations, tips, tricks, installation instructions, and so on. As an alternative to the one-time membership system, a periodic (e.g., per month) subscription service may be implemented. In this case, a renewable subscription fee may be charged, or the customer may be required to verify or update his or her membership information on the periodic basis.

The system 100 can also be setup like a peer-to-peer system that will allow various customers and/or vendors with items to list to be placed on the web site maintained by the server 103. The server then acts as a sales platform, and the operator can collect a transaction fee off every rental and sale.

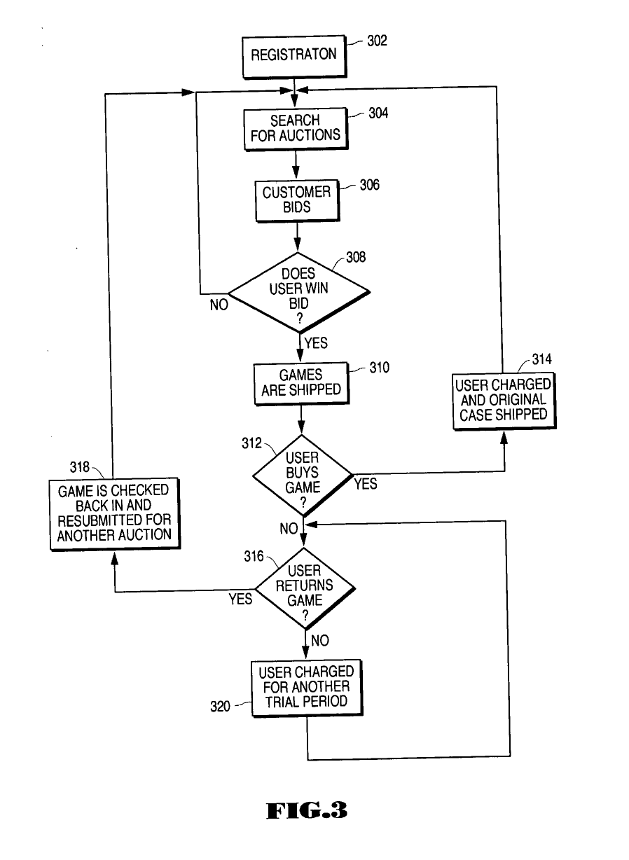

FIG. 3 is a flowchart illustrating the steps of processing and distributing product or content through the system of FIG. 1, according to one embodiment of the present invention. In step 302, a customer registers with the service through the web site. Typically, customers who visit the site will be able to register for free. The registration information to establish membership in the system includes standard contact/shipping information and a credit card for billing when they win bids or purchase games. At this time, customers will choose a user name that will be their identity on the system.

In step 304, the customer searches for auctions listed through the web site. Customers will be able to browse the catalog of titles/products using a variety of search methods. In each title/product details page there will be the title/product content. In addition to the content, there will be listed a section which will show the current auctions open. Customers will then choose an auction they wish to bid on.

Step 306 illustrates the bidding step. The auction pages for a particular title/product are for unique items. There may be many auctions currently running for a particular title/product. Customers will find an auction they wish to bid on and place a proxy bid for how much they would pay to play this title/product for the specified trial period. This is for the example in which the product is a game, movie, music clip, video clip, or similar finite length content product. This trial period can be any period of time, such as 3 days, one week, or similar. Auctions will end at pre-defined times and winners, as determined in step 308, will be notified via electronic mail, phone, or similar process. The sellers will be notified as well so they can prepare shipments to the winners. Sellers may be other people with content to share or sell, or vendors who maintain their own stores or web sites. At this time, the credit cards of all winners will be charged the corresponding winning bid amount plus a nominal, preset shipping charge. This charge is deposited into the sellers account and a check will be sent to the seller once per week if the amount passes a certain balance threshold.

In step 310 games are mailed out to the winners. The method used typically requires sellers to only ship out the disc (e.g., CD or DVD or floppy) in a protective hard sleeve. This is the most efficient balance between light weight, inexpensive shipping and disc protection. Shipping is typically first class mail with delivery confirmation, although other shipping methods (typically not to exceed $1 for a one way trip) can be used.

After shipping, the customer must decide whether to rent, return, or buy the item. Basically once customers receive the game or other content and play it, they have the trial period to determine whether they wish to keep it or buy it. Customers who keep the product past the trial period, will be automatically charged the bid price again and be given an additional trial period. This is determined in steps 312 and 316. If the customer does not wish to keep the game as determined in step 316, they can return it in the prepaid envelope provided, step 318. If the customer wishes to keep the game, they can choose an option on the web site and their credit card on file will be charged, step 314. This charge is deposited into the seller's account (with the charges from the bids) and a check will be sent to the seller on a periodic basis (e.g., once per week) if the amount passes a certain balance threshold. The seller will then ship the original product case and any materials to the customer, step 314.

Pricing Model

In one embodiment of the present invention, the price of the product comprises two components: a trial price and a “keep it” price. The trial price for the product can be determined in an auction-based system, as described above or in fixed-price method that is determined by a pricing formula that takes into account various factors, such as wholesale cost, demand for the item, inventory level, shipping costs, and various other factors. The final sales price can also be determined by a formula that combines elements of the auction and fixed-price systems.

The trial price sets the price the user pays for trying the product for the trial period. The keep it price sets the price the user pays if he or she elects to keep the product being evaluated. If a trial price is charged and paid, this amount may be deducted from the keep it price. This system allows users to try out a game, video, music CD, software program, or the like, in an on-line distribution system for a paid trial period prior to purchasing the product. In essence, a credit in the form of the trial price is awarded to the user if the product is to be ultimately purchased.

For the embodiment in which the trial and keep it price are determined by a fixed-price system, the following algorithms are used to determine the trial price and keep it price. The variables for the fixed-price formulae are as follows:
ppa—Post Price Adjustment (this is any special adjustment like a coupon or customers using membership rewards points to adjust the price of a particular product).
msrp—Manufacturer's Suggested Retail Price
tt—Total copies in trial for a particular game title.
ts—Total copies in stock and in trial for a particular game title.
rp—Rental period.
pd—Rental price per day.
MTP—Minimum Trial Price.
   The Trial Price (TP) formula to determine the rice which customers may trial a game before they actually buy the product is as follows:
   TP=(tt/ts)*rp*pd−ppa (1)
   For the above formula, TP is greater than or equal to MTP, (tt/ts) is known as the Popularity Coefficient (PC) and is used to determine the relative popularity of a game. The PC is between 0 and 1 where 0 is an extremely unpopular game and 1 is an extremely popular game.

An example illustrating the setting of a trial price is:

tt=80

ts=100

rp=15 days

pd=$0.55

ppa=$0.00

MTP=$2.50

Here, the Trial Price=(80/100)*15*0.55-0.00=$6.60

The Keep it Price (KP) formula to determine the prices that customers will pay to own a game they currently have out on trial is as follows:
KP=msrp−(TP*0.75)−ppa (2)
The reduction variable to the Trial Price (TP), shown above as 75%, can be set to any value depending upon how much of a deduction or credit is allowed for the paid trial period. A reduction variable of 100% allows the entire trial price to be deducted from the keep it price. A lesser deduction, such as 75% increases the purchase price by crediting the customer with only a portion of their trial price.

An example illustrating the setting of the keep it price is as follows:

msrp=$49.95

TP=$6.60

ppa=$5.00 off coupon

Here, the keep it price, KP=49.95−(6.60*0.75)−5.00=$40.00

The above examples illustrate how the final sale price of the product is composed of a trial price and keep it price component which are both based on fixed-price models.

In an alternative embodiment, the trial price (TP) can be determined through an auction process, as described previously. For this embodiment, the keep it price, KP is determined through formula (2) above, where the TP variable is determined through auction, and not by formula (1).

Inventory Management

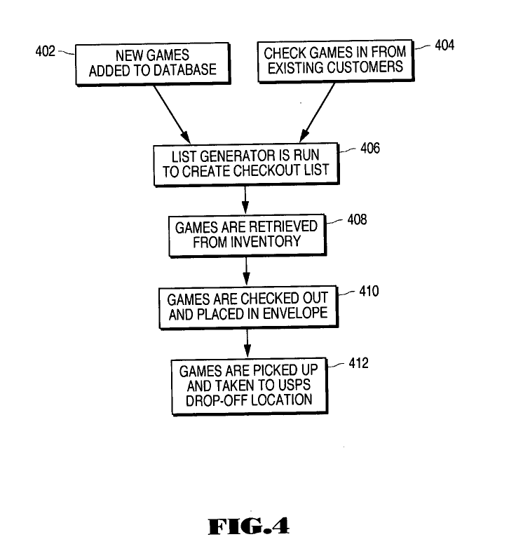

In one embodiment of the present invention, inventory is managed by the operator of network server 104 by a product inventory system 120. This program includes processes that facilitate adding new games or products to the catalog and the database, selling older titles, and general inventory management (taking stock, sorting, and so on). FIG. 4 is a flowchart that illustrates the steps of inventory management and shipping, according to one embodiment of the present invention.

In step 402, new games are added to the catalog on a regular periodic basis, such as once a week, and are updated immediately onto the web site. The function to add new games to the catalog can be accessed in the main inventory management system 120. For the case of video or computer games, the inventory personnel inputs various parameters such as information regarding the game—console platform, game name, genre, ESRB (Entertaining Software Ratings Board) rating, publisher name, developer name, release date, retail price, number of players, number of discs, game guides or manuals, an upload of the game box shot, and the game description. This information is currently obtained from a variety of sources.

In addition to the catalog, new games must be added to the product inventory database. Unlike adding unique titles to the catalog, adding games to the database involves physically adding copies of newly acquired inventory into the database, step 402. First, the game discs are removed from the original game cases and placed into a productized sleeve, clamshell, jacket or similar case. Then the game is entered into the database by using the inventory management system 120. The inventory personnel enters the game identifier and the price paid for the game. Then, a serial number is assigned and printed from the label printer, and the serial number is then placed onto the game disc.

Once a game has a certain number of excess titles in inventory, games are sold to ensure inventory equilibrium. In this manner, older or surplus games are removed from the system. Games can be sold through third-party vendors or directly to customers through direct sales channels. A customer informs the vendor that they wish to buy a game and they are then billed immediately. The game is then sent with the original case. If the customer is currently holding the game, such as during a trial period, the original case is sent out.

General inventory management tasks must also be performed by the system. General inventory management tasks include: sorting of games alphabetically when they come back from customers, step 404, or when new games are added to the database; fixing scratched discs; and stock checks on a monthly basis to keep the inventory correct and up to date.

Ultimately delivering the product to the customer requires the use of mailing (sending) operations. Mailing operations encompasses the daily operation of checking in, checking out, and packaging the games for delivery.

With regard to checking games in, games may come back from the post office on a daily basis. First, they must be opened and the games removed. Then, the games are checked in using an automated system requiring keying in serial number from the games. The system then adds the game back to the inventory list and also sends out an email to the customers stating their game was been returned, step 406.

After all games have been checked in (and all current customer service items have been handled and new games added to the database), the list generator will be activated. The list generator pulls the list of games and whom they will be sent to. Next, the games are actually pulled from the inventory, step 408.

Once the games have been pulled, the check out interface is used to check the games out and to print an address label for each game. A game serial number is entered into the interface and the game is automatically checked out to the user, an email is sent, and a label is printed. The game is then placed in the packaging envelope and then the label is affixed, step 410.

For actual delivery, games are taken by personnel to a postal hub or courier depot for drop off, step 412. Mail courier services may also be used to sort the mail and allow for use of bulk mail rates.

Although embodiments of the invention discussed with relation to FIGS. 3 and 4 were described with reference to game content, it should be understood that other types of digital content are also covered, such as music, video, program, text, or similar products and data.

In an alternative embodiment, the client computer represents a networked computing device or game console that can receive and playback streaming data from the server computer 104 or content provider 103. In this case, the data provided by sales process 112 is streaming data that is transmitted directly over network 110. Such content may be time sensitive to be disabled after a certain time period, unless purchased by the user. Alternatively a software or hardware key may be provided by the user to unlock the program upon purchase by the user.

Other features, aspects, and implementation details regarding embodiments of the present invention are provided in materials attached to the application herewith.

In the foregoing, a system has been described for the on-line distribution and purchase of entertainment media with an innovative trial price determination method. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A method of distributing a product to a customer, comprising the computer-implemented steps of:
receiving registration information from the customer, the registration information including identifying information and shipping address information of the customer;
receiving information regarding a product the customer desires to obtain;
providing the customer a selection of auctions in which the specified product is available for sale;
receiving one or more bids for the product from the customer and shipping the product to the customer for pre-determined trial period if the customer wins the product in auction, the customer's final bid price comprising the product purchase price;
determining whether the customer desires to purchase the product after the expiration of the trial period;
receiving the product back from the customer if the customer does not choose to purchase the product; and
shipping materials evidencing ownership of the product to the customer if the customer does choose to purchase the product.

2. The method of claim 1 wherein the registration information and product information is transmitted between a host computer and a client computer over a computer network as web pages comprising web content produced by a markup language, and wherein the web page is generated from a first computer executing a web server process, and transmitted to a second computer executing a web browser process.

3. The method of claim 1 wherein the product purchase price is required to exceed a minimum purchase price, the minimum purchase prices determined by a process taking account of parameters including wholesale product price, product demand, and product inventory level.

4. A method of distributing a product to a customer from a vendor, comprising the computer-implemented steps of:
receiving registration information from the customer, the registration information including identifying information and shipping address information of the customer;
receiving information regarding a product the customer desires to obtain;
setting a trial price to allow the customer to receive and evaluate the product for the duration of a pre-determined trial period, the trial price set by a market valuation of the product and a minimum purchase price, the minimum purchase prices determined by a process taking account of parameters including wholesale product price, product demand, and product inventory level;
determining whether the customer desires to purchase the product after the expiration of the trial period;
receiving the product back from the customer if the customer does not choose to purchase the product; and
shipping materials evidencing ownership of the product to the customer if the customer does choose to purchase the product.

5. The method of claim 4 wherein the registration information and product information is transmitted between a host computer and a client computer over a computer network as web pages comprising web content produced by a markup language, and wherein the web page is generated from a first computer executing a web server process, and transmitted to a second computer executing a web browser process.

6. A method of distributing a product to a customer, the method comprising the steps of:
defining a trial price for the product, which is paid by the customer to try the product for a pre-defined trial period, the trial price being set by the highest bid received in an auction made available to the customer;
defining a keep it price for the product, which is paid by the customer to keep the product after the trial period;
determining if the customer has elected to keep the product or return the product upon the expiration of the trial period;
charging the customer the keep it price if the customer elects to keep the product and sending the customer a product validation to evidence ownership of the product by the customer; and
checking the product back in and resubmitting it for another auction if the customer elects to return the product.

7. The method of claim 6 wherein the customer is given a second trial period and automatically charged the trial price a second time if the customer does not return the product upon expiration of the trial period.

8. The method of claim 6 wherein the product validation comprises original packaging and registration documentation for the product.

9. The method of claim 6 wherein the product is embodied within electronic media distributed over a computer network coupling a customer computer to a vendor computer.

10. The method of claim 6 wherein the product is embodied in a tangible media to be sent from a vendor to the customer.

11. The method of claim 6 wherein the auction is listed on a web site maintained by a vendor of the product.

12. A method of distributing a product to a customer, the method comprising the steps of:
defining a trial price for the product, which is paid by the customer to try the product for a pre-defined trial period, the trial price being set by a formula that factors a suggested retail price, an inventory level of the product and the duration of the trial period.
defining a keep it price for the product, which is paid by the customer to keep the product after the trial period;
determining if the customer has elected to keep the product or return the product upon the expiration of the trial period;
charging the customer the keep it price if the customer elects to keep the product and sending the customer a product validation to evidence ownership of the product by the customer; and
checking the product back in and resubmitting it for another auction if the customer elects to return the product.

13. The method of claim 12 wherein the customer is given a second trial period and automatically charged the trial price a second time if the customer does not return the product upon expiration of the trial period.

14. The method of claim 12 wherein the product validation comprises original packaging and registration documentation for the product.

15. The method of claim 12 wherein the product is embodied within electronic media distributed over a computer network coupling a customer computer to a vendor computer.

16. The method of claim 12 wherein the product is embodied in a tangible media to be sent from a vendor to the customer.

17. The method of claim 6 wherein the formula for the trial price further includes a factor reflecting a relative popularity of the product.

18. The method of claim 17 wherein the trial price exceeds a pre-determined minimum trial price.

19. The method of claim 12 wherein the keep it price is determined by a formula that factors a suggested retail price, the trial price, and a price adjustment.

20. The method of claim 19 wherein less than one hundred percent of the trial price is deducted from the keep it price.
